(19) United States
(12) Patent Application Publication
(10) Pub. No.: US 2004/0010394 A1
(43) Pub. Date: Jan. 15, 2004

(54) Systems, methods and computer program products for determining contaminant concentrations in semiconductor materials

(75) Inventor: Sergei V. Koveshnikov, Vancouver, WA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: SEH America, Inc.

(21) Appl. No.: 10/195,278

(22) Filed: Jul. 15, 2002

(51) Int. Cl. G06F 15/00

(52) U.S. Cl. 702/183

(57) ABSTRACT

A method of analyzing a semiconductor sample is provided. According to one embodiment, the method includes measuring the diffusion length of minority carriers in the semiconductor sample. The resistivity of the semiconductor sample is measured. A heavy metal concentration in the semiconductor sample is determined based upon the diffusion length and resistivity of the semiconductor sample.

### BACKGROUND OF THE INVENTION

1. Field of the Invention

The present invention relates to manufacturing and processing semiconductor materials and, more particularly, relates to systems, methods, and computer program products for measuring the concentration of heavy metal contaminants in semiconductor materials.

2. Description of Related Art

Semiconductor materials such as silicon (Si), germanium (Ge) and gallium arsenide (GaAs) are used extensively by the electronics industry in connection with the manufacture of a variety of electronic and optoelectronic devices and integrated circuits. To ensure the reliability of these devices and integrated circuits, semiconductor wafers must be produced and processed so as to minimize the introduction of heavy metal contaminants, such as chromium (Cr), iron (Fe), cobalt (Co), nickel (Ni), copper (Cu), and palladium (Pd), which can degrade the semiconductor wafers.

As a quality control measure, semiconductor wafers are commonly tested for heavy metal contaminants both before and after processing. One of the most common methods for testing for heavy metal contaminants involves measuring a property of the semiconductor material known as the minority carrier diffusion length (L), which indicates the effective distance that excess carriers diffuse through the semiconductor during their lifetime. In this regard, heavy metal contaminants form what are known as recombination centers that reduce carrier lifetime such that the concentration of heavy metal contaminants in a semiconductor wafer can be determined by measuring the diffusion length L.

The most common techniques for measuring the diffusion length L generally involve illuminating the semiconductor wafer with light using a probe and then measuring and analyzing the surface photovoltage (SPV) created thereby. If the energy of the incident photons is above the semiconductor band gap, the light impinging upon the surface of the semiconductor wafer will be absorbed and will produce excess carriers (holes and electrons). A certain number of the electron-hole pairs will reach the proximity of the surface through photogeneration and diffusion processes and become separated by the electric field of the surface-space charge region thereby producing an SPV. The SPV can be measured using an electrode placed proximate to the surface of the semiconductor wafer. The electrode is typically formed of a transparent conducting material so as not to interfere with the light impinging on the surface of the wafer.

The American Society for Testing and Materials (ASTM) recommends two methods for analyzing photovoltage to determine the diffusion length L. One method is the “constant magnitude surface photovoltage” (CMSPV) method, the principles of which are described by A. M. Goodman in A Method for the Measurement of Short Minority Carrier Diffusion Lengths in Semiconductors, J. Appl. Phys. 32, 2550 (1961), and were subsequently adopted as the ASTM Standard ANSI/ASTM F-391-78, p. 770 (1976) and are discussed in U.S. Pat. No. 4,333,051 entitled Method and Apparatus for Determining Minority Carrier Diffusion Length in Semiconductors, issued Jun. 1, 1982, all of which are hereby incorporated by reference. The second method is the linear constant photon flux method, as discussed in U.S. Pat. Nos. 5,025,145 and 5,177,351 to Lagowski, U.S. Pat. No. 5,663,657 to Lagowski et al., L. Jastrzebski et al., Solid State Technol. 35, 27 (1992), and J. Lagowski et al., Semicond. Sci. Technol. 7, A185 (1992), all of which are hereby incorporated by reference.

In both the CMSPV method and the linear constant photon flux method, the diffusion length L is calculated based on the following equation:

$$Δ n = Φ \frac{( 1 - R )}{\frac{D}{L} + S} \times \frac{1}{1 + {α}^{- 1} {L}^{- 1}} \qquad ( 1 )$$

where Δn is the excess minority carrier concentration, α is the absorption coefficient, α⁻¹ is the penetration depth, Φ is the incident photon flux, R is the reflectivity of the semiconductor material, D is the minority carrier diffusion constant, and S is the surface recombination velocity on the front surface of the semiconductor material. Equation (1) assumes that the diffusion length is short relative to the wafer thickness and that the light penetrates to a depth less than or equal to one-third the wafer thickness. Equation (1) is derived in Moss, J. Electronics and Control, 1, 126 (1955), which is hereby incorporated by reference.

The minority carrier diffusion constant D is calculated based on the following equation:

$$D = \frac{k T}{q μ} \qquad ( 2 )$$

where k is the Boltzman's constant, T is the temperature, q is the elementary charge, and μ is the minority carrier mobility.

According to the CMSPV method, there is assumed to be a monotonic relationship between carrier concentration and photovoltage. The CMSPV method includes illuminating the semiconductor wafer with several different wavelengths of incident light. The photon flux Φ is adjusted for each wavelength in order to maintain a constant magnitude of SPV for all wavelengths. Since the SPV is maintained at a constant magnitude, the carrier concentration is assumed to also remain at a constant magnitude. The corresponding photon flux Φ for each wavelength is measured and plotted versus the light penetration depth α⁻¹ of the semiconductor wafer at the corresponding photon flux Φ. This plot is then linearly extrapolated to determine the intercept along the light penetration depth axis to obtain the minority carrier diffusion length L (i.e., L=−α⁻¹ where Φ=0).

According to the linear constant photon flux method, the semiconductor wafer is illuminated with several different wavelengths of incident light having a low intensity where the SPV is a linear function of the photon flux Φ and where parameters on the right side of equation (1) are substantially constant. Under these conditions, the SPV is directly proportional to the carrier concentration Δn, or SPV=(constant) (Δn), where the constant depends on the semiconductor doping and the surface charge, but does not depend on the photon flux Φ. In this regard, the effective photon flux entering the semiconductor material, Φ_{eff}=Φ(1−R), is constant for all wavelengths and, thus, for all penetration depths α⁻¹. The diffusion length L is determined by plotting the inverse of the SPV signal, Φ_{eff}/SPV, as a function of the penetration depth α⁻¹. The diffusion length L is the intercept value L=α⁻¹ᵢₙₜ at Φ_{eff}/SPV=0.

It is commonly recognized that heavy metal contaminants form complexes with other elements, such as dopants or other impurities. For example, iron-boron (FeB) pairs can be can formed in a boron (B) doped wafer due to coulombic attraction between positively charged iron and negatively charged boron atoms. Iron can also form pairs with other shallow acceptors, such as aluminum and gallium. Since heavy metals are more effective at reducing carrier lifetime when dissociated from these pair defects, the diffusion length L obtained using either the CMSPV method or the linear constant photon flux method, as described above (hereinafter designated L₀), may not accurately reflect the actual heavy metal concentration in the wafer. Accordingly, under both the CMSPV method and the linear constant photon flux method, an additional series of measurements are typically performed to measure the diffusion length L₁ when the heavy metals have been dissociated from the pair defects.

The operations performed to measure the diffusion length L₁ when the heavy metals have been dissociated from the pair defects include pair separation using either optical or thermal activation to thereby dissociate or break the bond between the component elements of the pair. Optical activation involves impinging the surface of the wafer with a high intensity light, such as a halogen light. Thermal activation involves annealing the wafer. After the activation step, the corresponding steps set forth above for the CMSPV method or the linear constant photon flux method are repeated to obtain a second value of diffusion length L.

Once the diffusion lengths L₀ and L₁ have been determined, the heavy metal concentration can be determined. For example, the concentration of iron [Fe] in boron doped silicon wafer can be determined using the following equation:

$$[ Fe ] = 1.06 \times {10}^{16} \times ( \frac{1}{{L}_{1}^{2}} - \frac{1}{{L}_{0}^{2}} ) {L}_{1} \qquad ( 3 )$$

The two-step testing process conventionally used for determining heavy metal concentrations in a semiconductor wafer is relatively time consuming and complex, thus increasing the overall cost associated with producing and processing semiconductor wafers. Additionally, the number of operations performed in connection with the conventional testing processes increases the likelihood of an error in determining the diffusion length L and, thus, the corresponding heavy metal concentration. The conventional testing processes also fail to take into account other defects or impurities that exist in the semiconductor wafer and the contribution of these on the diffusion length.

Accordingly, there remains a need for a more simplified testing process for determining heavy metal concentrations in semiconductor materials. The testing process should provide an accurate and cost effective method for determining heavy metal concentrations, including taking into account the effect of other factors, such as impurities, on the diffusion length. In addition, the testing process should be compatible with existing SPV testing machines using either the CMSPV method or the linear constant photon flux method.

### SUMMARY OF THE INVENTION

The present invention satisfies these and other needs of the prior art by providing a method for accurately and cost effectively determining heavy metal concentrations in semiconductor materials. The present invention provides a method, computer program product, and system for analyzing a semiconductor sample. According to one embodiment, the method for analyzing a semiconductor sample includes the operations of determining the concentration of a heavy metal in the semiconductor sample based upon the diffusion length of minority carriers in the semiconductor sample and the resistivity of the semiconductor sample. This method has been principally developed for determination of iron impurities. However, a similar approach can be used to determine chromium, cobalt, nickel, copper, or palladium. In one embodiment, the determining step comprises determining the heavy metal concentration from a plot of the diffusion length as a function of the resistivity of the semiconductor sample.

According to another embodiment of the present invention, the method for analyzing a semiconductor sample includes determining the concentration of a heavy metal in the semiconductor sample based upon the lifetime of minority carriers in the semiconductor sample and the resistivity of the semiconductor sample. In one embodiment, the determining step includes determining the heavy metal concentration from a plot of the lifetime as a function of the resistivity of the semiconductor sample.

According to another embodiment, the method of analyzing a semiconductor sample includes determining the concentration of a heavy metal in the semiconductor sample based upon the diffusion length of minority carriers in the semiconductor sample and the concentration of an impurity in the semiconductor sample. The impurity can comprise a variety of materials, including boron, phosphorus or antimony. In one embodiment, the determining step includes measuring the resistivity of the semiconductor sample and, thereafter, determining the concentration of the impurity from the resistivity of the semiconductor sample. In another embodiment, the determining step includes determining the heavy metal concentration from a plot of the diffusion length as a function of the concentration of the impurity in the semiconductor sample.

In yet another embodiment of the present invention, the method of analyzing a semiconductor sample includes determining the concentration of a heavy metal in the semiconductor sample based upon the lifetime of minority carriers in the semiconductor sample and the concentration of an impurity in the semiconductor sample. In one embodiment, the determining step includes measuring the resistivity of the semiconductor sample and, thereafter, determining the concentration of the impurity from the resistivity of the semiconductor sample. In another embodiment, the determining step includes determining the heavy metal concentration from a plot of the lifetime as a function of the concentration of the impurity in the semiconductor sample.

According to still another embodiment of the present invention, the method of analyzing a semiconductor sample includes measuring the diffusion length of minority carriers in the semiconductor sample. The resistivity of the semiconductor sample is measured. A heavy metal concentration in the semiconductor sample is determined based upon the diffusion length and resistivity of the semiconductor sample. In one embodiment, the determining step includes determining the heavy metal concentration from a plot of the diffusion length as a function of the resistivity of the sample. In another embodiment, the second measuring step comprises determining the concentration of an impurity in the semiconductor sample from the resistivity of the semiconductor sample. Thereafter, the heavy metal concentration in the semiconductor sample is determined based upon the diffusion length and concentration of the impurity in the semiconductor sample. For example, the heavy metal concentration can be determined from a plot of the diffusion length as a function of the concentration of the impurity in the sample.

In one embodiment, the diffusion length is measured by illuminating a region of the semiconductor sample with light at a series of wavelengths to thereby produce a surface photovoltage at least partially on the semiconductor sample. Each wavelength of light has a corresponding photon flux. The surface photovoltage from the illuminated region of the semiconductor sample is measured. The photon flux of the light is determined such that the surface photovoltage is substantially constant for each wavelength. The photon flux is plotted as a function of light penetration depth. The light penetration depth is then determined where the function intercepts the light penetration axis, thus providing the diffusion length.

In another embodiment, the diffusion length is measured by illuminating a region of the semiconductor sample with light at a series of wavelengths to thereby produce a surface photovoltage at least partially on the semiconductor sample. Each wavelength of light has a corresponding photon flux. The photon flux of the light is controlled to be substantially constant for all wavelengths and at a level where the surface photovoltage of the semiconductor sample is a linear function of the photon flux. The surface photovoltage from the illuminated region of the semiconductor sample is measured. The inverse of surface photovoltage is plotted as a function of light penetration depth. The light penetration depth where the function intercepts the light penetration axis is determined, thus providing the diffusion length.

The present invention also provides a computer program product for analyzing a semiconductor sample. The computer program product comprises a computer-readable storage medium having computer-readable program code portions stored therein. According to one embodiment of the present invention, the computer-readable program portions include an executable portion for determining the concentration of a heavy metal in the semiconductor sample based upon the diffusion length of minority carriers in the semiconductor sample and the resistivity of the semiconductor sample. According to another embodiment of the present invention, the computer-readable program portions include an executable portion for determining the concentration of a heavy metal in the semiconductor sample based upon the lifetime of minority carriers in the semiconductor sample and the resistivity of the semiconductor sample.

According to yet another embodiment of the present invention, the computer-readable program portions include an executable portion for determining the concentration of a heavy metal in the semiconductor sample based upon the diffusion length of minority carriers in the semiconductor sample and the concentration of an impurity in the semiconductor sample. According to still another embodiment of the present invention, the computer-readable program portions include an executable portion for determining the concentration of a heavy metal in the semiconductor sample based upon the lifetime of minority carriers in the semiconductor sample and the concentration of an impurity in the semiconductor sample. In one embodiment, the executable portion receives data representing the resistivity of the semiconductor sample, and then determines the concentration of the impurity from the resistivity of the semiconductor sample.

According to yet another embodiment of the present invention, the computer-readable program portions include an executable portion that receives data representing the diffusion length of minority carriers in the semiconductor sample. The executable portion receives data representing the resistivity of the semiconductor sample. The executable portion then determines a heavy metal concentration in the semiconductor sample based upon the diffusion length and resistivity of the semiconductor sample. In one embodiment, the executable portion determines the concentration of an impurity in the semiconductor sample from the resistivity of the semiconductor sample and determines a heavy metal concentration in the semiconductor sample based upon the diffusion length and the concentration of the impurity in the sample.

The present invention also provides a system for analyzing a semiconductor sample. According to one embodiment, the system includes a processing element capable of receiving data representing the diffusion length of minority carriers in the semiconductor sample. The processing element is also capable of receiving data representing the resistivity of the semiconductor sample. The processing element is additionally capable of determining a heavy metal concentration in the semiconductor sample based upon the diffusion length and resistivity of the semiconductor sample. In one embodiment, the processing element is capable of determining the concentration of an impurity in the semiconductor sample from the resistivity of the semiconductor sample and then determining the concentration of a heavy metal in the semiconductor sample based upon the diffusion length and the concentration of the impurity in the sample.

Accordingly, there is provided systems, methods, and computer program products for measuring the concentration of heavy metal contaminants in semiconductor materials. The method of the present invention provides a greatly simplified testing process for determining heavy metal concentrations in semiconductor materials, which process is cost effective and accurately takes into account the effect of impurities on the diffusion length. In addition, the testing process of the present invention is compatible with existing SPV testing machines using either the CMSPV method or the linear constant photon flux method.

### BRIEF DESCRIPTION OF THE DRAWINGS

The foregoing and other advantages and features of the invention, and the manner in which the same are accomplished, will become more readily apparent upon consideration of the following detail description of the invention taken in conjunction with the accompanying drawings, which illustrate preferred and exemplary embodiments and which are not necessarily drawn to scale, wherein:

FIG. 1 is a flow chart illustrating the operations performed to determine the concentration of a heavy metal in a semiconductor sample, according to one embodiment of the present invention;

FIG. 2 is a flow chart illustrating the operations performed to determine the concentration of a heavy metal in a semiconductor sample, according to another embodiment of the present invention;

FIG. 3 is a flow chart illustrating the operations performed to determine the concentration of a heavy metal in a semiconductor sample, according to another embodiment of the present invention;

FIG. 4 is a flow chart illustrating the operations performed to determine the concentration of a heavy metal in a semiconductor sample, according to yet another embodiment of the present invention;

FIG. 5 is a flow chart illustrating the operations performed to determine the concentration of a heavy metal in a semiconductor sample, according to still another embodiment of the present invention;

FIG. 6 is a graph representing the concentration of iron [Fe] in a semiconductor sample based upon a plot of the diffusion length L as a function of boron [B] concentration, according to one embodiment of the present invention;

FIG. 7 is a graph representing the concentration of iron [Fe] in a semiconductor sample based upon a plot of minority carrier lifetime τ as a function of boron [B] concentration, according to one embodiment of the present invention;

FIG. 8 is a graph representing the concentration of iron [Fe] in a semiconductor sample based upon a plot of the diffusion length as a function of substrate resistivity ρ, according to one embodiment of the present invention.

FIG. 9 is a graph representing the diffusion length in a semiconductor sample as a function of iron [Fe] concentration and boron [B] concentration, according to one embodiment of the present invention;

FIG. 10 is a graph representing minority carrier lifetime τ in a semiconductor sample as a function of iron [Fe] concentration and boron [B] concentration, according to one embodiment of the present invention; and

FIG. 11 is a graph representing the resistivity ρ of silicon as a function of impurity concentration for both n-type and p-type wafers, as is known in the art.

### DETAILED DESCRIPTION OF THE INVENTION

The present invention now will be described more fully hereinafter with reference to the accompanying drawings, in which some, but not all embodiments of the invention are shown. This invention may be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

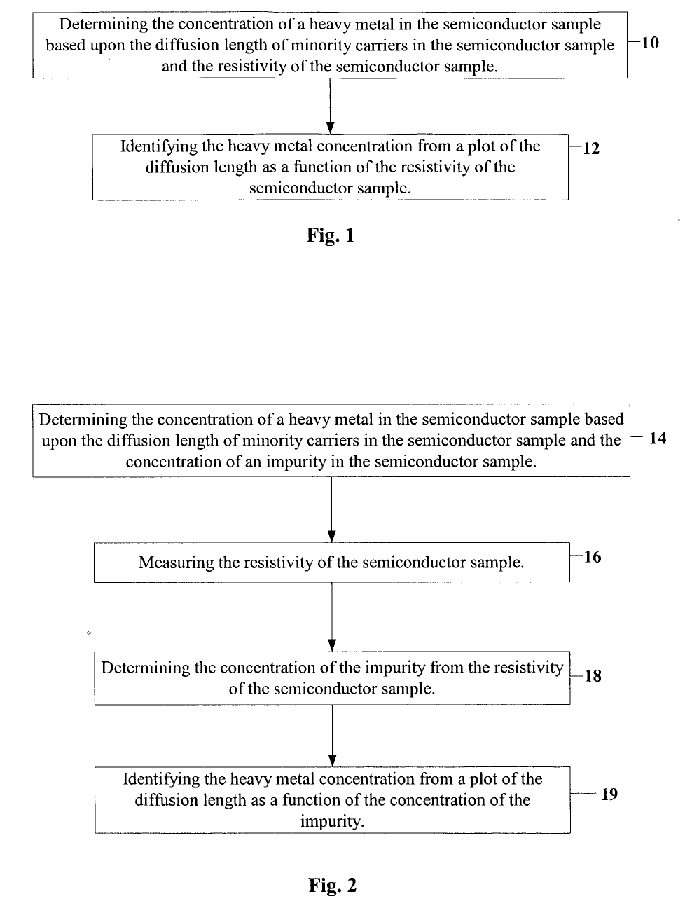

Referring now to the drawings, and in particular to FIG. 1, there are illustrated the operations performed to determine the concentration of a heavy metal in a semiconductor sample, according to one embodiment of the present invention. While the present invention has been developed principally to determine the concentration of iron [Fe] in a semiconductor sample, a similar approach can be used to determine the concentration of any of a number of heavy metal contaminants found in semiconductor materials that degrade material performance, including, but not limited to, chromium, iron, cobalt, nickel, copper, or palladium. As illustrated in FIG. 1, the concentration of the subject heavy metal in the semiconductor sample is determined based upon the diffusion length L of minority carriers in the sample and the resistivity ρ of the sample. See block 10. The diffusion length L of the minority carriers in the sample can be determined in various manners, including using either the CMSPV method or the linear constant photon flux method to determine L₀, as discussed above. The resistivity ρ of the sample can be determined in various manners, including using conventional testing equipment that steps probes over the sample in a predetermined pattern and then displays the data in various formats such as contour maps, single-dimensional cross-sectional profiles, and percent deviation. Alternatively, the resistivity ρ can be determined using mathematical equations known to those skilled in the art, e.g., see F. Shimura, Semiconductor Silicon Crystal Technology, 96-97 (1989), and W. R. Runyan and K. E. Bean, Semiconductor Integrated Circuits Processing Technology, 418-421 (1994), both of which are hereby incorporated by reference. For example, as explained by F. Shimura, the resistivity ρ of silicon crystals doped with boron or phosphorus can be calculated from the dopant concentration. For boron-doped silicon, the resistivity ρ is provided by the following equation:

$$ρ = \frac{1.305 \times {10}^{16}}{[ B ]} + \frac{1.133 \times {10}^{17}}{[ B ]} ( 1 + {( 2.58 \times {10}^{- 19} [ B ] )}^{- 0737} ) \qquad ( 4 )$$

where the resistivity ρ is in ohm·cm and [B] is the concentration of boron in atoms/cm³. For phosphorus-doped silicon, the resistivity ρ is provided by the following equation:

$$ρ = ( \frac{6.242 \times {10}^{18}}{[ P ]} ) \times {10}^{Z} \qquad ( 5 )$$

where [P] is the concentration of boron in atoms/cm³ and Z is provided by the following equation:

$$Z = \frac{( {A}_{0} + {A}_{1} y + {A}_{2} {y}^{2} + {A}_{3} {y}^{3} )}{( 1 + {B}_{1} y + {B}_{2} {y}^{2} + {B}_{3} {y}^{3} )} \qquad ( 6 )$$

where y=(log₁₀[P])−16, A₀=−3.0769, A₁=2.2108, A₂=−0.62272, A₃=0.057501, B₁=−0.68157, B₂=0.19833, and B₃=−0.018376.

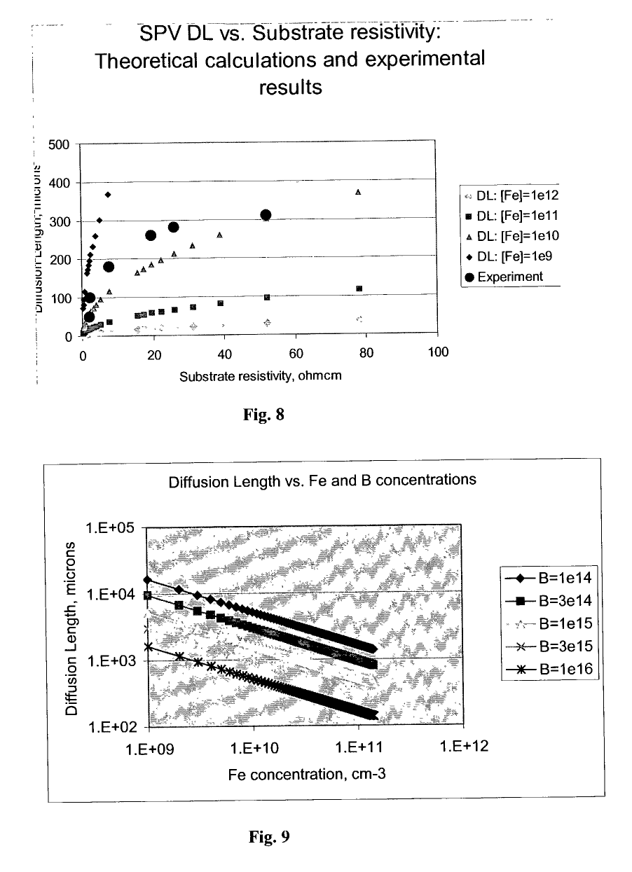

Once the diffusion length L and the resistivity ρ are determined for the subject sample, the heavy metal concentration can be determined from a graph plotting diffusion length L for different heavy metal concentrations as a function of the resistivity ρ of the samples. See block 12. Such a graph can be prepared in various manners by one of ordinary skill in the art, for example by using theoretical calculations or by determining the diffusion lengths and heavy metal concentrations using conventional methodology in the manner described above using the CMSPV method or the linear constant photon flux method, and plotting the diffusion lengths for several heavy metal concentrations as a function of the resistivity ρ of the samples. As an example, FIG. 8 illustrates a graph plotting diffusion length L as a function of substrate resistivity ρ in a boron doped p-type wafer for various concentrations of iron [Fe] ranging from about 1×10⁹ atoms/cm³ to about 1×10¹² atoms/cm³. The diffusion length L and the resistivity ρ of the new sample are compared to those presented on this graph and then the heavy metal concentration of the new sample is directly determined from the graph.

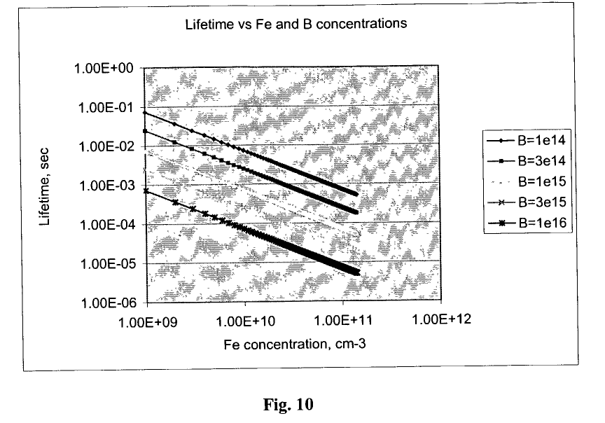

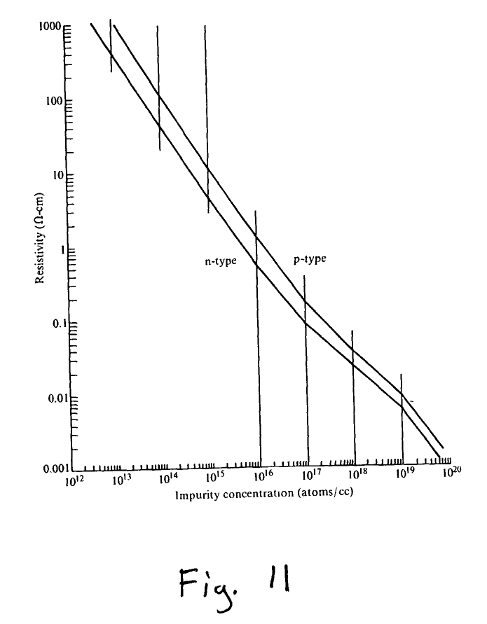

As illustrated in FIG. 11, the resistivity ρ of a semiconductor wafer depends at least in part on the concentration of impurities in the wafer. Additionally, it can be shown that the minority carrier lifetime τ and the diffusion length L depend at least in part on the resistivity ρ of the semiconductor sample and, thus, depend at least in part on the concentration of impurities in the wafer. In this regard, the minority carrier lifetime τ in a boron doped silicon wafer having iron as a heavy metal contaminant can be expressed using the following equation.

$$τ = \frac{exp [ \frac{( {E}_{F} - {E}_{FeB} )}{k T} ]}{{c}_{n}} \times [ Fe ] \qquad ( 7 )$$

where the capture cross-section for electrons (cₙ) is 6.5×10⁻⁵ cm³ sec⁻¹, the energy band gap for iron-boron (E_{FeB}) is 0.1 eV, E_{F} is the Fermi level, kT is 0.026 eV at room temperature, and [Fe] is the concentration of iron. The Fermi level E_{F} (and, thus, the minority carrier lifetime τ) in turn depend at least in part on the concentration of boron [B], as shown by the following equation.

$${E}_{i} - {E}_{F} = k T ln ( \frac{[ B ]}{{n}_{i}} ) \qquad ( 8 )$$

where E₁ is the midrange band gap width of silicon, [B] is the concentration of boron, and n₁ is the intrinsic electron concentration at a given temperature (T). The dependence of the diffusion length L and the minority carrier lifetime τ on the impurity concentration in the semiconductor sample is illustrated graphically in FIGS. 9 and 10, respectfully. FIG. 9 illustrates the diffusion length L plotted as a function of iron concentration [Fe] for various concentrations of boron [B] ranging from about 1×10¹⁴ atoms/cm³ to about 1×10¹⁶ atoms/cm³ in a boron-doped silicon wafer. FIG. 10 illustrates the minority carrier lifetime τ plotted as a function of iron concentration [Fe] for various concentrations of boron [B] ranging from about 1×10¹⁴ atoms/cm³ to about 1×10¹⁶ atoms/cm³ in a boron-doped silicon wafer.

Accordingly, by using the resistivity ρ to determine the heavy metal concentration within the semiconductor sample, the method of the present invention takes into account the impurity concentration within the sample. Thus, the method of the present invention not only simplifies the analysis process for determining heavy metal concentration in semiconductor samples by eliminating the interstitial molecule activation step and the subsequent steps involved in determining the diffusion length L₁, as described above in connection with the conventional CMSPV method and the linear constant photon flux method, but the method of the present invention also provides a more accurate determination of heavy metal concentration since it factors into the determination the effects caused by impurities, such as dopants, on the diffusion length.

According to another embodiment of the present invention, as illustrated in FIG. 2, the concentration of the subject heavy metal in the semiconductor sample is determined based upon the diffusion length L of minority carriers in the sample and the concentration of an impurity in the sample. See block 14. The diffusion length L of the minority carriers in the sample can be determined in various manners, including using either the CMSPV method or the linear constant photon flux method to determine L₀ in the manner described above. The impurity in the sample can include any of a number of impurities commonly found in semiconductor materials, including, but not limited to, dopants such as boron, aluminum or gallium. The impurity concentration in the sample can be determined in various manners that are well known to those skilled in the art. For example, the impurity concentration can be determined by first measuring the resistivity ρ of the sample, as described above. See block 16. The concentration of the impurity can then be determined from the resistivity ρ of the sample using mathematical equations, for example in the manner described above for boron- and phosphorus-doped silicon. See block 18.

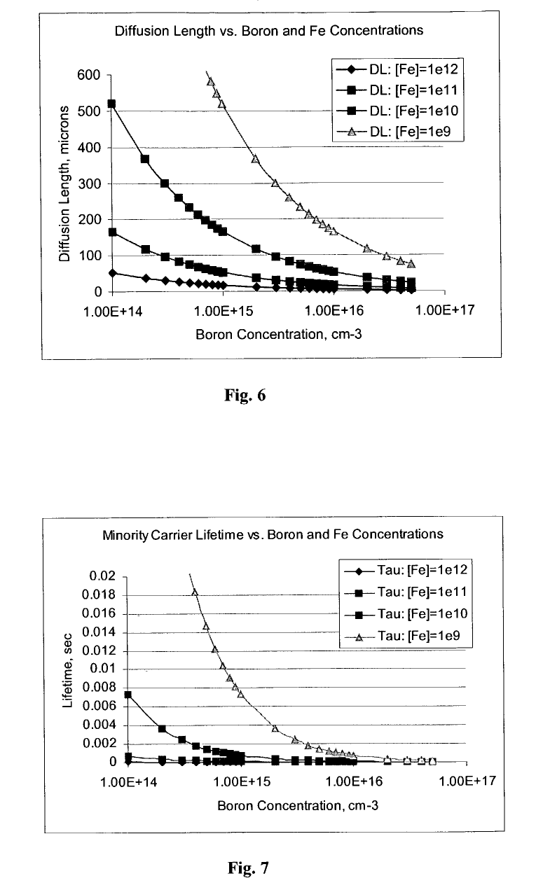

Once the diffusion length L and the impurity concentration are determined for the subject sample, the heavy metal concentration can be determined from a graph plotting diffusion length L for different heavy metal concentrations as a function of the impurity concentration. See block 19. Such a graph can be prepared in various manners by one of ordinary skill in the art, for example by using theoretical calculations or by determining the diffusion lengths and heavy metal concentrations using conventional methodology in the manner described above using the CMSPV method or the linear constant photon flux method, and plotting the diffusion lengths for several heavy metal concentrations as a function of the impurity concentration in the samples. As an example, FIG. 6 illustrates a graph plotting diffusion length L as a function of the concentration of boron [B] in a boron doped p-type wafer for various concentrations of iron [Fe] from 1×10⁹ atoms/cm³ to 1×10¹² atoms cm³. The diffusion length L and the impurity concentration of the new sample are determined in the manner described above and then plotted on the graph. The heavy metal concentration can then be directly determined from the graph.

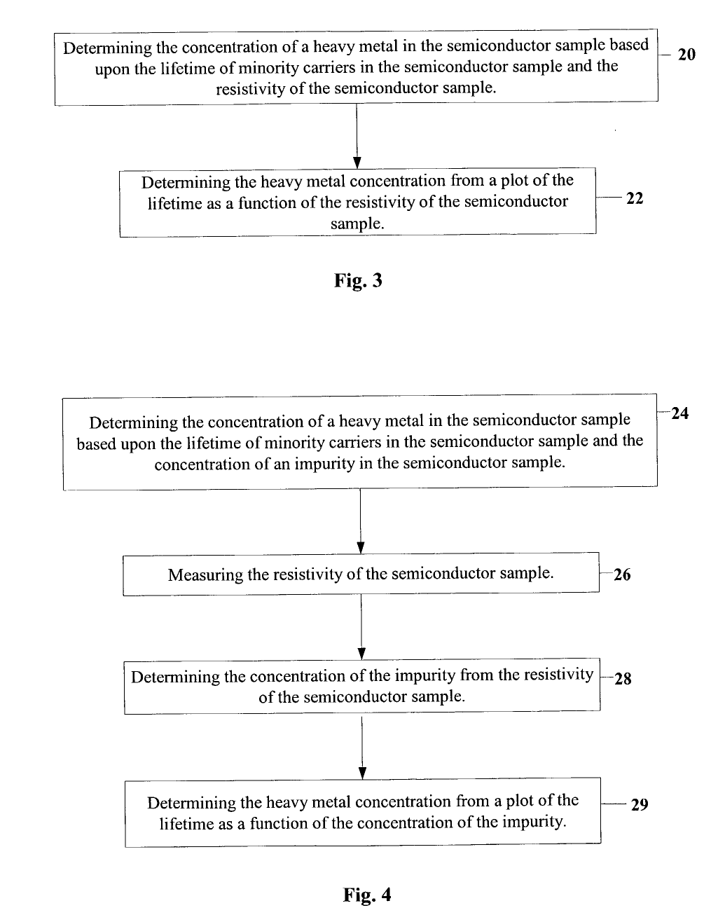

According to yet another embodiment of the present invention, as illustrated in FIG. 3, the concentration of the subject heavy metal in the semiconductor sample is determined based upon the lifetime τ of minority carriers in the sample and the resistivity ρ of the sample. See block 20. The lifetime τ of minority carriers in the sample can be determined in various manners, including Laser-Microwave Photo-Conductance Decay (“LM-PCD”), as is well known to those skilled in the art. The resistivity ρ of the sample can be determined in the manner described above. Once the lifetime τ of minority carriers and the resistivity ρ are determined for the subject sample, the heavy metal concentration can be determined from a graph plotting the lifetime τ of minority carriers for different heavy metal concentrations as a function of the resistivity ρ. See block 22. Such a graph can be prepared in various manners by one of ordinary skill in the art, for example by using theoretical calculations or by determining the lifetime τ of minority carriers and heavy metal concentrations using conventional methodology in the manner described above, and plotting the lifetime τ of minority carriers for several heavy metal concentrations as a function of the resistivity ρ of the samples. The diffusion length L and the impurity concentration of the new sample are determined in the manner described above and then plotted on the graph. The heavy metal concentration can then be directly determined from the graph.

According to yet another embodiment of the present invention, as illustrated in FIG. 4, the concentration of the subject heavy metal in the semiconductor sample is determined based upon the lifetime τ of minority carriers in the sample and the concentration of an impurity in the sample. See block 24. The lifetime ρ of minority carriers in the sample and the impurity concentration in the sample can be determined in the manners described above. For example, the impurity concentration can be determined by first measuring the resistivity ρ of the sample. See block 26. The concentration of the impurity can then be determined from the resistivity ρ of the sample using mathematical equations such as those described above for boron- and phosphorus-doped silicon. See block 28. Once the lifetime τ of minority carriers and the impurity concentration are determined for the subject sample, the heavy metal concentration can be determined from a graph plotting the lifetime τ of minority carriers for different heavy metal concentrations as a function of impurity concentration. See block 22. Such a graph can be prepared in various manners by one of ordinary skill in the art, for example by using theoretical calculations or by determining the lifetime τ of minority carriers and heavy metal concentrations using conventional methodology in the manner described above, and plotting the lifetime τ of minority carriers for several heavy metal concentrations as a function of the impurity concentration of the samples. As an example, FIG. 7 illustrates a graph plotting minority carrier lifetime τ as a function of the concentration of boron [B] in a boron doped p-type wafer for various concentrations of iron [Fe] from 1×10⁹ atoms/cm³ to 1×10¹² atoms/cm³. The minority carrier lifetime τ and the impurity concentration of the new sample are determined in the manner described above, and then plotted on the graph. The heavy metal concentration can then be directly determined from the graph.

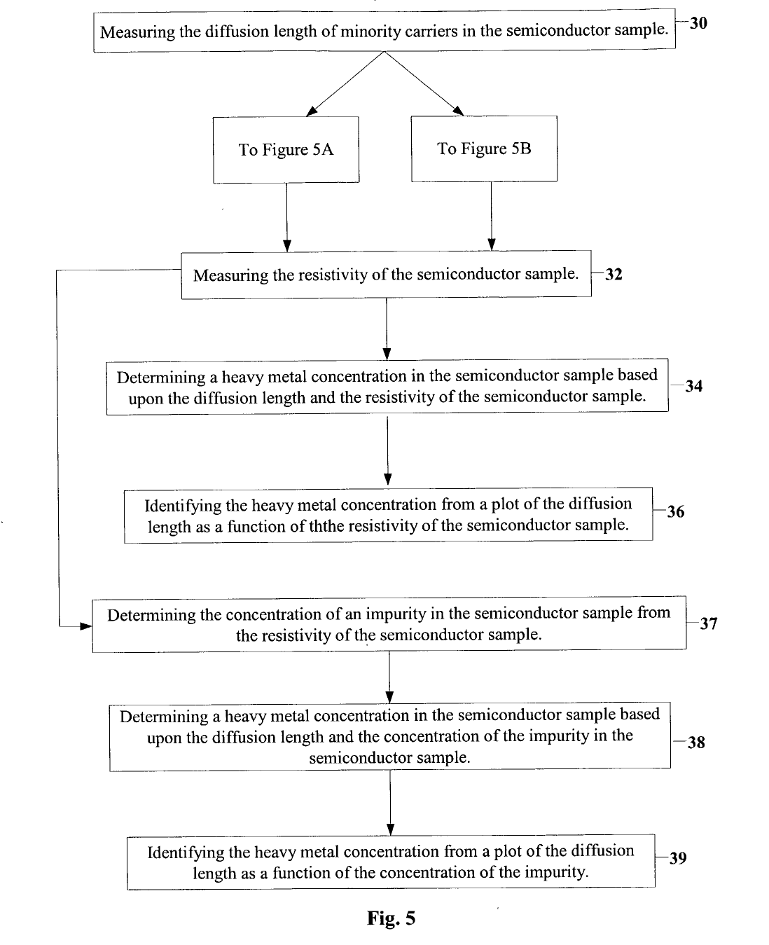

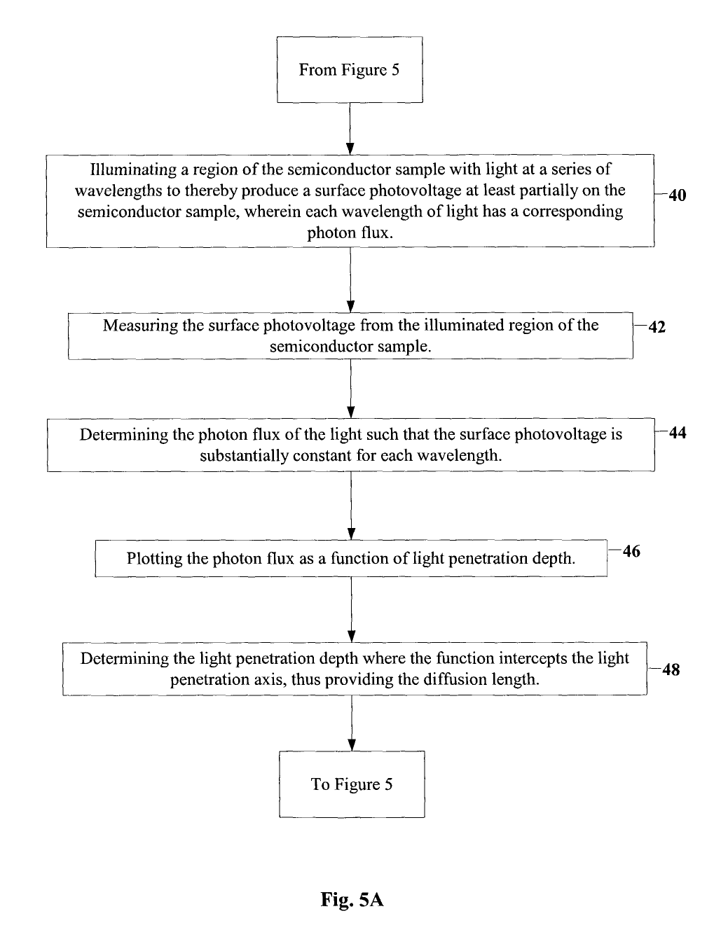

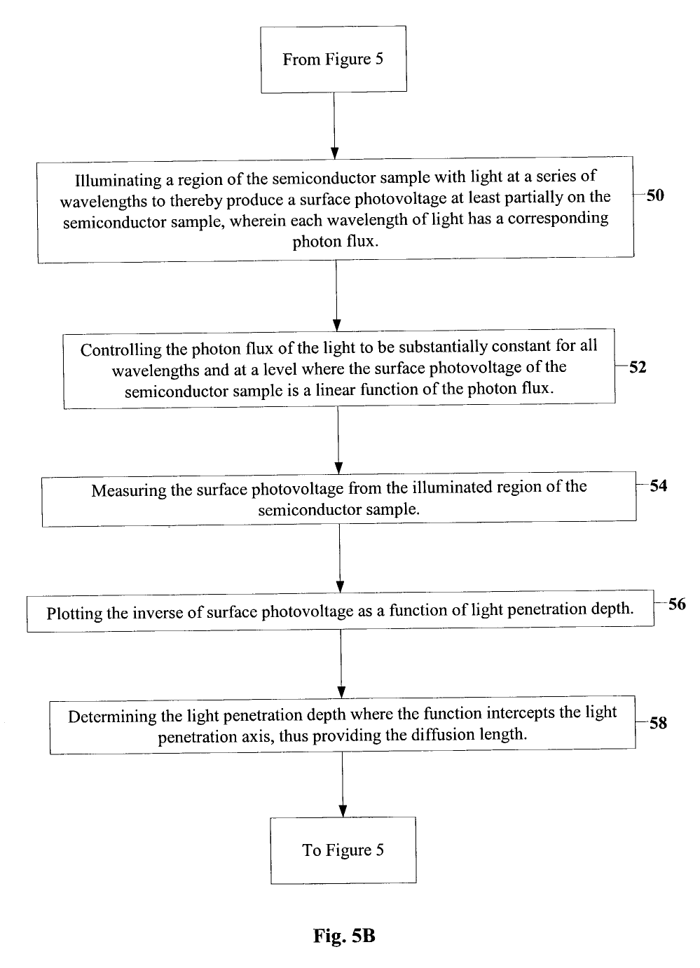

FIG. 5 illustrates a method for analyzing a semiconductor sample, according to still another embodiment of the present invention. As illustrated in FIG. 5, the diffusion length L of minority carriers in the semiconductor sample is measured. See block 30. According to one embodiment, as illustrated in FIG. 5A, the diffusion length is determined by illuminating a region of the semiconductor sample with light at a series of wavelengths to thereby produce a surface photovoltage on the semiconductor sample. See block 40. Each wavelength of light has a corresponding photon flux. The surface photovoltage from the illuminated region of the semiconductor sample is measured. See block 42. The photon flux of the light is determined such that the surface photovoltage is substantially constant for each wavelength. See block 44. The photon flux is plotted as a function of light penetration depth. See block 46. The light penetration depth is then determined where the function intercepts the light penetration axis, thus providing the diffusion length. See block 48.

FIG. 5B illustrates another embodiment for determining the diffusion length L. As illustrated in FIG. 5B, the diffusion length L is determined by illuminating a region of the semiconductor sample with light at a series of wavelengths to thereby produce a surface photovoltage on the semiconductor sample. See block 50. Each wavelength of light has a corresponding photon flux. The photon flux of the light is controlled to be substantially constant for all wavelengths and at a level where a surface photovoltage of the semiconductor sample is a linear function of the photon flux. See block 52. The surface photovoltage from the illuminated region of the semiconductor sample is measured. See block 54. The inverse of surface photovoltage is plotted as a function of light penetration depth. See block 56. The light penetration depth where the function intercepts the light penetration axis is determined, thus providing the diffusion length. See block 58.

As illustrated in FIG. 5, once the diffusion length L is determined, the resistivity ρ is measured. See block 32. In one embodiment, a heavy metal concentration in the semiconductor sample is determined based upon the diffusion length and the resistivity of the semiconductor sample. See block 34. The heavy metal concentration is determined from a plot of the diffusion length as a function of resistivity. See block 36. In another embodiment, the concentration of an impurity in the semiconductor sample is determined from the resistivity of the semiconductor sample. See block 37. The heavy metal concentration is then determined from a plot of the diffusion length as a function of the concentration of the impurity. See block 38. More specifically, the heavy metal concentration is determined from a plot of the diffusion length as a function of the concentration of the impurity. See block 39.

FIGS. 1, 2, 3, 4, 5, 5A, and 5B are block diagrams, flowcharts and control flow illustrations of methods, systems and program products according to the invention. It will be understood that each block or step of the block diagrams, flowcharts and control flow illustrations, and combinations of blocks in the block diagrams, flowcharts and control flow illustrations, can be implemented by computer program instructions. These computer program instructions may be loaded onto a computer or other programmable apparatus to produce a machine, such that the instructions which execute on the computer or other programmable apparatus create means or devices for implementing the functions specified in the block diagrams, flowcharts or control flow block(s) or step(s). These computer program instructions may also be stored in a computer-readable memory that can direct a computer or other programmable apparatus to function in a particular manner, such that the instructions stored in the computer-readable memory produce an article of manufacture, including instruction means or devices which implement the functions specified in the block diagrams, flowcharts or control flow block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block diagrams, flowcharts or control flow block(s) or step(s).

Accordingly, blocks or steps of the block diagrams, flowcharts or control flow illustrations support combinations of means or devices for performing the specified functions, combinations of steps for performing the specified functions and program instruction means or devices for performing the specified functions. It will also be understood that each block or step of the block diagrams, flowcharts or control flow illustrations, and combinations of blocks or steps in the block diagrams, flowcharts or control flow illustrations, can be implemented by special purpose hardware-based computer systems which perform the specified functions or steps, or combinations of special purpose hardware and computer instructions.

The present invention also provides a computer program product for analyzing a semiconductor sample. Such a computer program product could be used in connection with an SPV machine for measuring diffusion length L. The computer program product comprises a computer-readable storage medium having computer-readable program code portions stored therein. According to one embodiment of the present invention, the computer-readable program portions include an executable portion for determining the concentration of a heavy metal in the semiconductor sample based upon the diffusion length of minority carriers in the semiconductor sample and the resistivity of the semiconductor sample. See block 10. According to another embodiment of the present invention, the computer-readable program portions include an executable portion for determining the concentration of a heavy metal in the semiconductor sample based upon the lifetime of minority carriers in the semiconductor sample and the resistivity of the semiconductor sample. See block 20.

According to yet another embodiment of the present invention, the computer-readable program portions include an executable portion for determining the concentration of a heavy metal in the semiconductor sample based upon the diffusion length of minority carriers in the semiconductor sample and the concentration of an impurity in the semiconductor sample. See block 14. According to still another embodiment of the present invention, the computer-readable program portions include an executable portion for determining the concentration of a heavy metal in the semiconductor sample based upon the lifetime of minority carriers in the semiconductor sample and the concentration of an impurity in the semiconductor sample. See block 24. In one embodiment, the executable portion receives data representing the resistivity of the semiconductor sample, which data can be input to the executable portion automatically or manually. The executable portion then determines the concentration of the impurity from the resistivity of the semiconductor sample. See blocks 18 and 28.

According to yet another embodiment of the present invention, the computer-readable program portions include an executable portion that receives data representing the diffusion length of minority carriers in the semiconductor sample, which data can be measured and thereafter input to the executable portion automatically or manually. See block 30. The executable portion receives data representing the resistivity of the semiconductor sample, which data can be measured and thereafter input to the executable portion automatically or manually. See block 32. The executable portion then determines a heavy metal concentration in the semiconductor sample based upon the diffusion length and resistivity of the semiconductor sample. See block 34. In one embodiment, the executable portion determines the concentration of an impurity in the semiconductor sample from the resistivity of the semiconductor sample and determines a heavy metal concentration in the semiconductor sample based upon the diffusion length and the concentration of the impurity in the sample. See blocks 37 and 38.

The present invention also provides a system for analyzing a semiconductor sample. According to one embodiment, the system includes a processing element capable of receiving data representing the diffusion length of minority carriers in the semiconductor sample, which data can be measured and thereafter input to the processing element automatically or manually. See block 30. The processing element is also capable of receiving data representing the resistivity of the semiconductor sample, which data can be measured and thereafter input to the processing element automatically or manually. See block 32. The processing element is additionally capable of determining a heavy metal concentration in the semiconductor sample based upon the diffusion length and resistivity of the semiconductor sample. See block 34. In one embodiment, the processing element is capable of determining the concentration of an impurity in the semiconductor sample from the resistivity of the semiconductor sample and then determining the concentration of a heavy metal in the semiconductor sample based upon the diffusion length and the concentration of the impurity in the sample. See blocks 37 and 38.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of analyzing a semiconductor sample, comprising:
determining the concentration of a heavy metal in the semiconductor sample based upon the diffusion length of minority carriers in the semiconductor sample and the resistivity of the semiconductor sample.

2. A method according to claim 1 wherein said determining step comprises determining the heavy metal concentration from a plot of the diffusion length as a function of the resistivity of the semiconductor sample.

3. A method according to claim 1 wherein the heavy metal comprises a material selected from the group consisting of chromium, iron, cobalt, nickel, copper, and palladium.

4. A method of analyzing a semiconductor sample, comprising:
determining the concentration of a heavy metal in the semiconductor sample based upon the diffusion length of minority carriers in the semiconductor sample and the concentration of an impurity in the semiconductor sample.

5. A method according to claim 4 wherein said determining step comprises:
measuring the resistivity of the semiconductor sample; and
determining the concentration of the impurity from the resistivity of the semiconductor sample.

6. A method according to claim 4 wherein said determining step comprises determining the heavy metal concentration from a plot of the diffusion length as a function of the concentration of the impurity in the semiconductor sample.

7. A method according to claim 4 wherein the impurity comprises a material selected from the group consisting of boron, phosphorus and antimony.

8. A method according to claim 4 wherein the heavy metal comprises a material selected from the group consisting of chromium, iron, cobalt, nickel, copper, and palladium.

9. A method of analyzing a semiconductor sample, comprising:
determining the concentration of a heavy metal in the semiconductor sample based upon the lifetime of minority carriers in the semiconductor sample and the resistivity of the semiconductor sample.

10. A method according to claim 9 wherein said determining step comprises determining the heavy metal concentration from a plot of the lifetime as a function of the resistivity of the semiconductor sample.

11. A method according to claim 9 wherein the heavy metal comprises a material selected from the group consisting of chromium, iron, cobalt, nickel, copper, and palladium.

12. A method of analyzing a semiconductor sample, comprising:
determining the concentration of a heavy metal in the semiconductor sample based upon the lifetime of minority carriers in the semiconductor sample and the concentration of an impurity in the semiconductor sample.

13. A method according to claim 12 wherein said determining step comprises:
measuring the resistivity of the semiconductor sample; and
determining the concentration of the impurity from the resistivity of the semiconductor sample.

14. A method according to claim 12 wherein said determining step comprises determining the heavy metal concentration from a plot of the lifetime as a function of the concentration of an impurity in the semiconductor sample.

15. A method according to claim 12 wherein the impurity comprises a material selected from the group consisting of boron, phosphorus and antimony.

16. A method according to claim 12 wherein the heavy metal comprises a material selected from the group consisting of chromium, iron, cobalt, nickel, copper, and palladium.

17. A method of analyzing a semiconductor sample, comprising:
measuring the diffusion length of minority carriers in the semiconductor sample;
measuring the resistivity of the semiconductor sample; and
determining a heavy metal concentration in the semiconductor sample based upon the diffusion length and resistivity of the semiconductor sample.

18. A method according to claim 17 wherein said first measuring step comprises:
illuminating a region of the semiconductor sample with light at a series of wavelengths to thereby produce a surface photovoltage at least partially on the semiconductor sample, each wavelength of light having a corresponding photon flux;
measuring the surface photovoltage from the illuminated region of the semiconductor sample;
adjusting the photon flux of the light such that the surface photovoltage is substantially constant for each wavelength;
plotting the photon flux as a function of light penetration depth; and
determining the light penetration depth where the function intercepts the light penetration axis.

19. A method according to claim 17 wherein said first measuring step comprises:
illuminating a region of the semiconductor sample with light at a series of wavelengths to thereby produce a surface photovoltage at least partially on the semiconductor sample, each wavelength of light having a corresponding photon flux;
controlling the photon flux of the light to be substantially constant for all wavelengths and at a level where a surface photovoltage of the semiconductor sample is a linear function of the photon flux;
measuring the surface photovoltage from the illuminated region of the semiconductor sample;
plotting the inverse of surface photovoltage as a function of light penetration depth; and
determining the light penetration depth where the function intercepts the light penetration axis.

20. A method according to claim 17 wherein said determining step comprises determining the heavy metal concentration from a plot of the diffusion length as a function of the resistivity of the semiconductor sample.

21. A method according to claim 17 wherein said second measuring step comprises determining the concentration of an impurity in the semiconductor sample from the resistivity of the semiconductor sample.

22. A method according to claim 21 wherein said second determining step comprising determining the heavy metal concentration based upon the diffusion length and the concentration of the impurity in the semiconductor sample.

23. A method according to claim 22 wherein said third determining step comprising determining the heavy metal concentration from a plot of the diffusion length as a function of the concentration of the impurity.

24. A computer program product for analyzing a semiconductor sample, said computer program product comprising a computer-readable storage medium having computer-readable program code portions stored therein, the computer-readable program portions comprising:
an executable portion for determining the concentration of a heavy metal in the semiconductor sample based upon the diffusion length of minority carriers in the semiconductor sample and the resistivity of the semiconductor sample.

25. A computer program product for analyzing a semiconductor sample, said computer program product comprising a computer-readable storage medium having computer-readable program code portions stored therein, the computer-readable program portions comprising:
an executable portion for determining the concentration of a heavy metal in the semiconductor sample based upon the diffusion length of minority carriers in the semiconductor sample and the concentration of an impurity in the semiconductor sample.

26. A computer program product according to claim 25 wherein said executable portion receives data representing the resistivity of the semiconductor sample, and wherein said executable portion determines the concentration of the impurity from the resistivity of the semiconductor sample.

27. A computer program product for analyzing a semiconductor sample, said computer program product comprising a computer-readable storage medium having computer-readable program code portions stored therein, the computer-readable program portions comprising:
an executable portion for determining the concentration of a heavy metal in the semiconductor sample based upon the lifetime of minority carriers in the semiconductor sample and the resistivity of the semiconductor sample.

28. A computer program product for analyzing a semiconductor sample, said computer program product comprising a computer-readable storage medium having computer-readable program code portions stored therein, the computer-readable program portions comprising:
an executable portion for determining the concentration of a heavy metal in the semiconductor sample based upon the lifetime of minority carriers in the semiconductor sample and the concentration of an impurity in the semiconductor sample.

29. A computer program product according to claim 28 wherein said executable portion receives data representing the resistivity of the semiconductor sample, and wherein said executable portion determines the concentration of the impurity from the resistivity of the semiconductor sample.

30. A computer program product for analyzing a semiconductor sample, said computer program product comprising a computer-readable storage medium having computer-readable program code portions stored therein, the computer-readable program portions comprising:
an executable portion receiving data representing the diffusion length of minority carriers in the semiconductor sample, wherein said executable portion receives data representing the resistivity of the semiconductor sample, and wherein said executable portion determines a heavy metal concentration in the semiconductor sample based upon the diffusion length and the resistivity of the semiconductor sample.

31. A computer program product according to claim 30 wherein said executable portion determines the concentration of an impurity in the semiconductor sample from the resistivity of the semiconductor sample and wherein said executable portion determines a heavy metal concentration in the semiconductor sample based upon the diffusion length and the concentration of the impurity in the semiconductor sample.

32. A system for analyzing a semiconductor sample, said system comprising:
a processing element capable of receiving data representing the diffusion length of minority carriers in the semiconductor sample, wherein said processing element is also capable of receiving data representing the resistivity of the semiconductor sample, and wherein said processing element is additionally capable of determining a heavy metal concentration in the semiconductor sample based upon the diffusion length and the resistivity of the semiconductor sample.

33. A system according to claim 32, wherein said processing element is capable of determining the concentration of an impurity in the semiconductor sample from the resistivity of the semiconductor sample, and wherein said processing element is additionally capable of determining a heavy metal concentration in the semiconductor sample based upon the diffusion length and the concentration of the impurity in the semiconductor sample.
